(19) United States
(12) Patent Application Publication
(10) Pub. No.: US 2010/0259489 A1
(43) Pub. Date: Oct. 14, 2010

(54) TOUCH CONTROL DISPLAY APPARATUS AND POSITION INDICATOR THEREOF

(76) Inventors: Hsin-Chung CHEN, Hsinchu (TW); Feng-Chuan Yeh, Hsinchu (TW); Yi-Ju Li, Hsinchu (TW)

Correspondence Address: LanWay IPR Services, P.O. Box 220746, Chantilly, VA, 20153, US

(21) Appl. No.: 12/473,133

(22) Filed: May 27, 2009

(30) Foreign Application Priority Data
Apr. 10, 2009 (TW) 098205962

(51) Int. Cl. G06F 3/041

(52) U.S. Cl. 345/173; 345/107

(57) ABSTRACT

A touch control display apparatus includes a touch control display and a position indicator. The housing of the display has a touch control displaying area and a receiving portion. The receiving portion has a first metal contact and a second metal contact. The first and the second metal contacts are electrically connected to a positive terminal and a negative terminal of an internal system power source of the display, respectively. The indicator is used for transmitting a position indicating signal to the display, such that the display could sense a position of the indicator located in the touch control displaying area accordingly. The housing of the indicator has a third metal contact and a fourth metal contact. The third and the fourth metal contacts are suitable for electrically connecting the first and the second metal contacts, respectively, such that the indicator could perform a charging operation.

This application claims the priority benefit of Taiwan application serial no. 098205962, filed on Apr. 10, 2009.

### BACKGROUND

1. Technical Field

The present invention generally relates to the field of a display and, more particularly, to a rechargeable position indicator and a touch control display apparatus using the same.

2. Description of the Related Art

Referring to FIG. 1, a conventional touch control display apparatus is shown. The touch control display apparatus 100 comprises a touch control display 102 and a position indicator 104. The touch control display 102 comprises an electrophoretic displaying device 106 and an electromagnetic digitizer 108. The electrophoretic displaying device 106 displays images by a touch control displaying area 110 thereof. The position indicator 104 is suitable for inputting coordinates in the touch control displaying area 110, so as to control the operations of the touch control display apparatus 100. The electromagnetic digitizer 108 is used for sensing a position of the position indicator 104 located in the touch control displaying area 110.

Referring to FIG. 2, a circuit structure of an internal circuit of the position indicator 104 is shown. The internal circuit of the position indicator 104 comprises a dry battery 202, a switch 204 and a resonant circuit 206. The resonant circuit 206 is used for transmitting a position indicating signal to the electromagnetic digitizer 108, such that the electromagnetic digitizer 108 could sense a position of the position indicator 104 located in the touch control displaying area 110 accordingly. The dry battery 202 is used for supplying an operation power to the resonant circuit 206. The switch 204 is electrically connected between a positive terminal of the dry battery 202 and an enabling signal input terminal EN of the resonant circuit 206. The switch 204 is used for determining whether to enable the resonant circuit 206 to transmit the position indicating signal. Certainly, the switch 204 may be disposed on the housing of the position indicator 104, such that users can turn on or turn off the switch 204 easily.

A disadvantage of the touch control display apparatus 100 is that users have to replace the battery 202 of the position indicator 104 when the dry battery 202 has run out of power. This will cause a great inconvenience, and the environmental issue.

### BRIEF SUMMARY

The present invention relates to a position indicator, which could perform a charging operation.

The present invention further relates to a touch control display apparatus, which adopts the aforementioned position indicator.

The present invention provides a position indicator of a touch control display. The position indicator comprises a housing, a first metal contact, a second metal contact, an indicating signal transmitting circuit and a rechargeable energy storage device. The first metal contact and the second metal contact are disposed on the housing. The indicating signal transmitting circuit is disposed in the housing, and is used for transmitting a position indicating signal to the touch control display. The rechargeable energy storage device is disposed in the housing, and is used for supplying an operation power to the indicating signal transmitting circuit. In addition, the rechargeable energy storage device is electrically connected to the first metal contact and the second metal contact, so as to electrically connect an external power to perform a charging operation via the first metal contact and the second metal contact.

The present invention provides a touch control display apparatus. The touch control display apparatus comprises a touch control display and a position indicator. A housing of the touch control display has a touch control displaying area and a receiving portion. The receiving portion has a first metal contact and a second metal contact. The first metal contact and the second metal contact are electrically connected to a positive terminal and a negative terminal of an internal system power source of the touch control display, respectively. The position indicator is used for transmitting a position indicating signal to the touch control display, such that the touch control display could sense a position of the position indicator located in the touch control displaying area. Further, the position indicator is suitable for being placed in the receiving portion. A housing of the position indicator has a third metal contact and a fourth metal contact. The third metal contact and the fourth metal contact are suitable for electrically connecting the first metal contact and the second metal contact, respectively, such that the position indicator could perform a charging operation.

In the present invention, two metal contacts are disposed on the housing of the position indicator, and the two metal contacts are electrically connected to an rechargeable energy storage device disposed in the position indicator, such that the rechargeable energy storage device could perform a charging operation via the two metal contacts when the rechargeable energy storage device has run out of power. Therefore, to replace the battery is not needed, and the environmental issue is solved. In addition, the touch control display further has a receiving portion, and the receiving portion also has two metal contacts. The two metal contacts of the receiving portion are electrically connected to a positive terminal and a negative terminal of an internal system power source in the touch control display. Thus, when the rechargeable energy storage device of the position indicator has run out of power, users could place the position indicator in the receiving portion to enable the four metal contacts be correspondingly connected, and therefore the touch control display could charge the rechargeable energy storage device of the position indicator.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a conventional touch control display apparatus.

FIG. 2 shows a circuit structure of an internal circuit of the position indicator.

FIG. 3 shows the appearance of the position indicator according to an embodiment of the present invention.

FIG. 4 shows the connections between the metal contacts and an internal circuit of the position indicator.

FIG. 5 shows the touch control display according to an embodiment of the present invention.

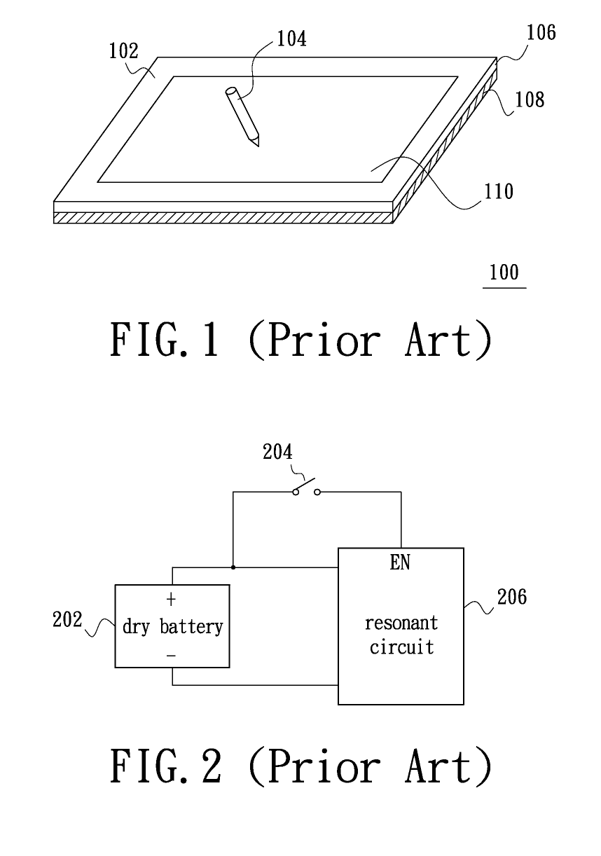

### DETAILED DESCRIPTION

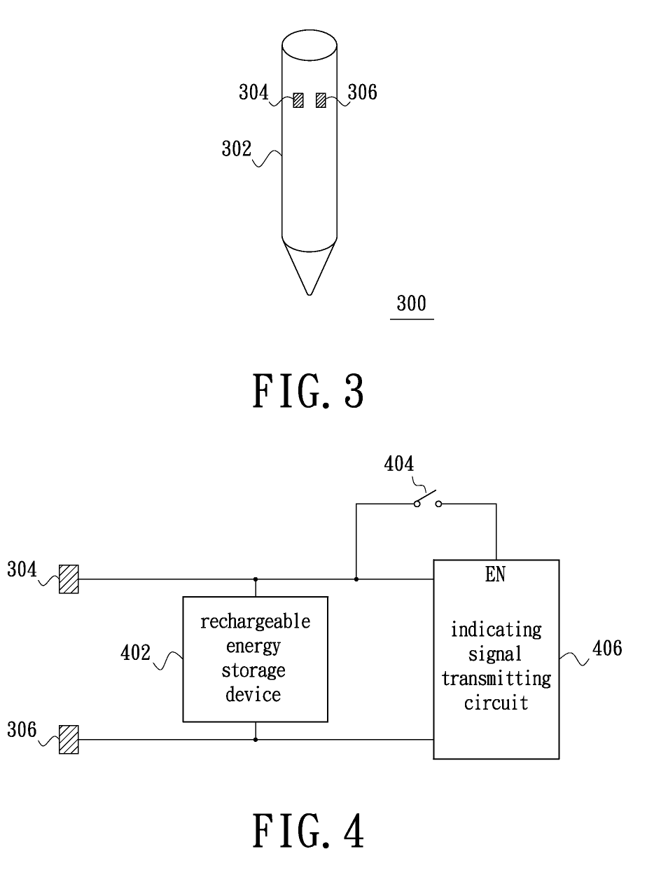

The present invention provides a touch control display apparatus. The touch control display apparatus comprises a touch control display and a position indicator. In the following description, a position indicator of the present invention is described at first. Referring to FIG. 3, the appearance of the position indicator according to an embodiment of the present invention is shown. As shown in FIG. 3, metal contacts 304 and 306 are disposed on the housing 302 of the position indicator 300. The functions of the two metal contacts will be described by the FIG. 4.

FIG. 4 shows the connections between the metal contacts 304 and 306 and an internal circuit of the position indicator 300. Referring to FIG. 4, the internal circuit of the position indicator 300 comprises a rechargeable energy storage device 402 and an indicating signal transmitting circuit 406. In addition, the position indicator 300 further comprises a switch 404. Referring to FIGS. 3 and 4, the indicating signal transmitting circuit 406 is disposed in the housing 302, and is used for transmitting a position indicating signal to the touch control display (this will be described later). The rechargeable energy storage device 402 is disposed in the housing 302, and is used for supplying an operation power to the indicating signal transmitting circuit 406. In addition, the rechargeable energy storage device 402 is electrically connected to the metal contacts 304 and 306, so as to electrically connect an external power to perform a charging operation via the metal contacts 304 and 306. A terminal of the switch 404 is electrically connected to the rechargeable energy storage device 402, and another terminal of the switch 404 is electrically connected to an enabling signal input terminal EN of the indicating signal transmitting circuit 406. The switch 404 is used for determining whether to enable the indicating signal transmitting circuit 406. Certainly, the switch 404 may be disposed on the housing 302 of the position indicator 300, such that users can turn on or turn off the switch 404 easily.

In this embodiment, the indicating signal transmitting circuit 406 may be implemented by a resonant circuit, and the rechargeable energy storage device 402 may be implemented by an ultracapacitor or a rechargeable button cell battery. However, these implementations are not limitations of the present invention. A benefit of employing an ultracapacitor or a rechargeable button cell battery as the rechargeable energy storage device 402 is that the size of the position indicator 300 will be relatively small. It is noted that the switch 404 is only used for determining whether to enable the indicating signal transmitting circuit 406, such that the enabling signal input terminal EN of the indicating signal transmitting circuit 406 could be directly connected to the rechargeable energy storage device 402 to omit the switch 404.

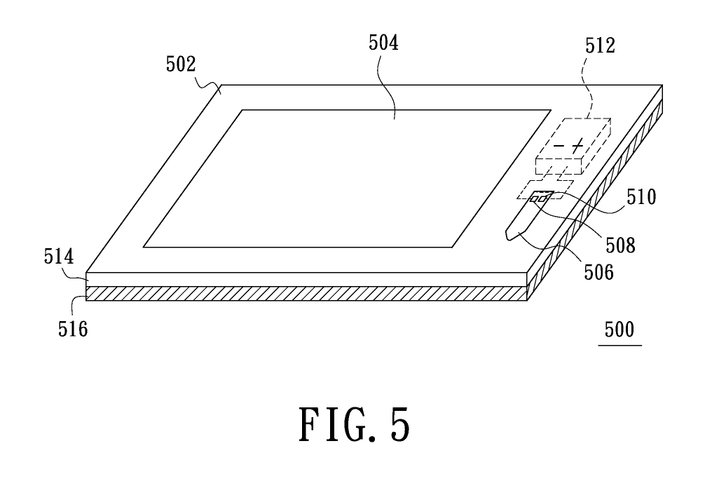

In the following description, a touch control display of the present invention will be described. Referring to FIG. 5, the touch control display according to an embodiment of the present invention is shown. As shown in FIG. 5, the housing 502 of the touch control display 500 has a touch control displaying area 504 and a receiving portion 506. The touch control displaying area 504 is used for displaying images. The position indicator 300 is suitable for inputting coordinates in the touch control displaying area 504, so as to control the operations of the touch control display 500. The receiving portion 506 has metal contacts 508 and 510. The metal contact 508 and the metal contact 510 are electrically connected to a negative terminal and a positive terminal of an internal system power source 512 of the touch control display 500, respectively. In this embodiment, the receiving portion 506 is a groove, and the position indicator 300 is suitable for being placed in the receiving portion 506. When the position indicator 300 is placed in the receiving portion 506, the metal contacts 304 and 306 on the housing 302 of the position indicator 300 could electrically connect the metal contacts 510 and 508 of the receiving portion 506, respectively, such that the position indicator 300 could perform a charging operation.

In addition, in this embodiment, the touch control display 500 consist of an electrophoretic displaying device 514 and an electromagnetic digitizer 516. The electrophoretic displaying device 514 has a first surface and a second surface. The first surface has the touch control displaying area 504 and the receiving portion 506. The electromagnetic digitizer 516 is disposed on the second surface of the electrophoretic displaying device 514, and is used for sensing the position of the position indicator 300 located in the touch control displaying area 504 according to the position indicating signal. In addition, in this embodiment, the touch control display 500 is an electronic book reader.

To sum up, in the present invention, two metal contacts are disposed on the housing of the position indicator, and the two metal contacts are electrically connected to an rechargeable energy storage device disposed in the position indicator, such that the rechargeable energy storage device could perform a charging operation via the two metal contacts when the rechargeable energy storage device has run out of power. Therefore, to replace the battery is not needed, and the environmental issue is solved. In addition, the touch control display further has a receiving portion, and the receiving portion also has two metal contacts. The two metal contacts of the receiving portion are electrically connected to a positive terminal and a negative terminal of an internal system power source in the touch control display. Thus, when the rechargeable energy storage device of the position indicator has run out of power, users could fix the position indicator in the receiving portion to enable the four metal contacts be correspondingly connected, and therefore the touch control display could charge the rechargeable energy storage device of the position indicator.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A position indicator of a touch control display, comprising:
a housing;
a first metal contact, disposed on the housing;
a second metal contact, disposed on the housing;
an indicating signal transmitting circuit, disposed in the housing and used for transmitting a position indicating signal to the touch control display; and
a rechargeable energy storage device, disposed in the housing, wherein the rechargeable energy storage device is used for supplying an operation power to the indicating signal transmitting circuit, the rechargeable energy storage device is electrically connected to the first metal contact and the second metal contact, so as to electrically connect an external power to perform a charging operation via the first metal contact and the second metal contact.

2. The position indicator as claimed in claim 1, further comprising a switch, wherein the switch is disposed on the housing, a terminal of the switch is electrically connected to the rechargeable energy storage device, and another terminal of the switch is electrically connected to an enabling signal input terminal of the indicating signal transmitting circuit, and the switch is used for determining whether to enable the indicating signal transmitting circuit.

3. The position indicator as claimed in claim 1, wherein the indicating signal transmitting circuit is implemented by a resonant circuit.

4. The position indicator as claimed in claim 1, wherein the rechargeable energy storage device is implemented by an ultracapacitor or a rechargeable button cell battery.

5. A touch control display apparatus, comprising:
a touch control display, wherein a housing of the touch control display has a touch control displaying area and a receiving portion, the receiving portion has a first metal contact and a second metal contact, and the first metal contact and the second metal contact are electrically connected to a positive terminal and a negative terminal of an internal system power source of the touch control display respectively; and
a position indicator, wherein the position indicator is used for transmitting a position indicating signal to the touch control display, such that the touch control display senses a position of the position indicator disposed in the touch control displaying area accordingly, the position indicator is suitable for being placed in the receiving portion, a housing of the position indicator has a third metal contact and a fourth metal contact, and the third metal contact and the fourth metal contact are suitable for electrically connecting the first metal contact and the second metal contact, respectively, such that the position indicator could perform a charging operation.

6. The touch control display apparatus as claimed in claim 5, wherein the touch control display comprises:
an electrophoretic displaying device, wherein the electrophoretic displaying device has a first surface and a second surface, and the first surface has the touch control displaying area and the receiving portion; and
an electromagnetic digitizer, wherein the electromagnetic digitizer is disposed on the second surface of the electrophoretic displaying device, and is used for sensing the position of the position indicator located in the touch control displaying area according to the position indicating signal.

7. The touch control display apparatus as claimed in claim 5, wherein an internal circuit of the position indicator comprises:
an indicating signal transmitting circuit, wherein the indicating signal transmitting circuit is used for transmitting the position indicating signal to the touch control display; and
a rechargeable energy storage device, wherein the rechargeable energy storage device is used for supplying an operation power to the indicating signal transmitting circuit, and the rechargeable energy storage device is electrically connected to the third metal contact and the fourth metal contact, so as to perform the charging operation via the third metal contact and the fourth metal contact.

8. The touch control display apparatus as claimed in claim 7, wherein the position indicator further comprises a switch, the switch is disposed on the housing of the position indicator, a terminal of the switch is electrically connected to the rechargeable energy storage device, and another terminal of the switch is electrically connected to an enabling signal input terminal of the indicating signal transmitting circuit, the switch is used for determining whether to enable the indicating signal transmitting circuit.

9. The touch control display apparatus as claimed in claim 7, wherein the indicating signal transmitting circuit is implemented by a resonant circuit.

10. The touch control display apparatus as claimed in claim 7, wherein the rechargeable energy storage device is implemented by an ultracapacitor or a rechargeable button cell battery.

11. The touch control display apparatus as claimed in claim 5, wherein the receiving portion is a groove.

12. The touch control display apparatus as claimed in claim 5, wherein the touch control display is an electronic book reader.
